(19) United States
(12) Patent Application Publication
(10) Pub. No.: US 2013/0236613 A1
(43) Pub. Date: Sep. 12, 2013

(54) Kitchen Appliance and Method of Using the Same

(71) Applicant: Marta Phillips, Midlothian, VA (US)

(72) Inventor: Marta Phillips, Midlothian, VA (US)

(21) Appl. No.: 13/417,212

(22) Filed: Mar. 10, 2012

(51) Int. Cl. A47J 27/62; A23L 1/01; A47J 36/00

(52) U.S. Cl. 426/231; 99/332; 219/442; 219/489; 219/506

(57) ABSTRACT

A slow cooker includes a housing and a heating element to heat a heating cavity of the housing. The heating element is operable in only a single cooking mode and only a single warming mode. A container is sized and shaped to fit within the heating cavity of the housing. A lid is sized and shaped to at least partially cover the opening of the container. A controller is configured to control operation of the heating element in either the single cooking mode or the single warming mode. A control knob is rotatably mounted to the housing and is operatively connected to the controller. Rotation of the control knob causes a controller to actuate the heating element to heat contents within the container to a first predetermined temperature at a selected amount of time.

### SUMMARY

The present disclosure relates generally to a kitchen appliance and, more particularly, to a slow cooker that simplifies and/or expedites the process of heating contents therein.

### BACKGROUND OF THE DISCLOSURE

Kitchen appliances, and particularly slow cookers, are well known. Conventional slow cookers allow or require a user to select both a cooking temperature and a cooking time during which a heating element of the slow cooker operates. Other conventional slow cookers allow or require a user to select a cooking temperature or cooking level, which in turn correlates to a default cooking time. For example, conventional slow cookers include a control panel with a plurality of buttons. The buttons may allow a user to place the slow cooker in one of several different modes of operation, select a cooking time from a range of possible cooking times, and/or select or modify a cooking temperature from a range of possible cooking temperatures.

FIG. 1 shows a temperature versus time graph for a conventional slow cooker having a high heat setting (“HS”) and a low heat setting (“LS”). When using such a conventional slow cooker, a user is required to choose either the HS or the LS. When set to the HS, contents (i.e., foodstuff or another objection) within the conventional slow cooker reaches a temperature of approximately one hundred degrees Celsius (100° C.) in a relatively short period of time, such as approximately five hours (5 hrs). In contrast, when set to the LS, the contents within the conventional slow cooker reaches the same temperature of approximately one hundred degrees Celsius (100° C.) only after a longer period of time, such as approximately twelve hours (12 hrs).

While the conventional slow cookers described above are quite acceptable and useful, users and consumers would always appreciate a simpler and less complicated kitchen appliance relative to conventional operation. It has heretofore not been discovered how to make the operation of a slow cooker more user friendly. As such, there is an ongoing need for a slow cooker appliance that performs certain steps or functions automatically. The device and method of the present disclosure overcome and/or eliminate at least one of the above or other shortcomings of conventional appliances.

### BRIEF SUMMARY OF THE DISCLOSURE

Briefly stated, one aspect of the present disclosure is directed to a slow cooker having a housing with a base wall and a side wall extending therefrom. Portions of the base wall and side wall define a heating cavity within the housing. The housing has a housing rim at a free edge of the side wall defining an opening to the heating cavity. A heating element is disposed within the housing sufficiently proximate the heating cavity to heat the heating cavity. The heating element is operable in only a single cooking mode and only a single warming mode. A container has a generally hollow interior and a container rim that defines an opening for accessing an interior thereof. The interior of the container is capable of retaining contents therein. The container is sized and shaped to fit within the heating cavity of the housing. A lid is sized and shaped to at least partially cover the opening of the container when the lid is placed on the container. The lid has an exterior surface and an opposing interior surface facing the interior of the container when the lid is placed on the container. A controller is mounted to the housing and is configured to control operation of the heating element in either the single cooking mode or the single warming mode. A control knob is rotatably mounted to the housing and is operatively connected to the controller. Rotation of the control knob causes a controller to actuate the heating element to heat the heating cavity.

In another aspect, the present disclosure is directed to a slow cooker having a housing with a base wall and a side wall extending therefrom. Portions of the base wall and side wall define a heating cavity within the housing. The housing has a housing rim at a free edge of the side wall defining an opening to the heating cavity. A heating element is disposed within the housing sufficiently proximate the heating cavity to heat the heating cavity. A container has a generally hollow interior and a container rim defining an opening for accessing the interior thereof. The interior of the container is capable of retaining contents therein. The container is sized and shaped to fit at least partially within the heating cavity of the housing. A lid is sized and shaped to at least partially cover the opening of the container when the lid is placed on the container. The lid has an exterior surface and an opposing interior surface facing the interior of the container when the lid is placed on the container. The controller is configured to control operation of the heating element. A control knob is mounted to the housing and is operably connected to the controller. The control knob is rotatable with respect to the housing which causes the controller to actuate the heating element to heat the contents within the container to a first predetermined temperature at a selected amount of time. The control knob is depressible with respect to the housing which causes the controller to place the heating element in one of an operating condition and a non-operating condition.

In yet another aspect, the present disclosure is directed to a method of heating contents to be consumed within a slow cooker over a period of time. The slow cooker includes a housing having a base wall and a side wall. Portions of the base wall and side wall define a heating cavity within the housing. The housing has a housing rim and a free edge of the side wall defining an opening to the heating cavity. The heating element is disposed within the housing sufficiently proximate the heating cavity to heat the heating cavity. A container has a generally hollow interior and a container rim defining an opening for accessing the interior thereof. The interior of the container is capable of retaining contents therein. The container is sized and shaped to fit at least partially within the heating cavity of the housing. A lid is sized and shaped to at least partially cover the opening of the container when the lid is placed on the container. The lid has an exterior surface and an opposing interior surface facing the interior of the container when the lid is placed on the container. A controller is configured to control operation of the heating element. A control knob is mounted to the housing and is operatively connected to the controller. The method includes the steps of inserting contents into the interior of the container, placing the lid on the container, depressing the control knob with respect to the side wall of the housing to place the heating element in an operating condition, and rotating the control knob with respect to the housing which causes the controller to actuate the heating element in a cooking mode to heat the contents within the container to a first predetermined temperature at a selected period of time.

### BRIEF DESCRIPTION OF THE SEVERAL VIEWS OF THE DRAWINGS

The foregoing summary, as well as the following detailed description of a preferred embodiment of the disclosure, will be better understood when read in conjunction with the appended drawings. For the purpose of illustrating the disclosure, there is shown in the drawings an embodiment which is presently preferred. It should be understood, however, that the disclosure is not limited to the precise arrangements and instrumentalities shown. In the drawings:

FIG. 1 is a temperature versus time graph of contents, such as foodstuff or another object, within a conventional slow cooker;

FIG. 2 is a top perspective view of a kitchen appliance in accordance with a preferred embodiment of the present disclosure;

FIG. 3 is a left side elevation view thereof;

FIG. 4 is a top plan view thereof;

FIG. 5 is an enlarged cross-sectional side elevation view thereof;

FIG. 6 is a schematic block diagram of a controller and related components of the kitchen appliance shown in FIG. 2; and

FIG. 7 is a temperature versus time graph of contents, such as foodstuff or another objection, within the kitchen appliance shown in FIG. 2.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly” and “outwardly” refer to directions toward and away from, respectively, the geometric center of the kitchen appliance, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

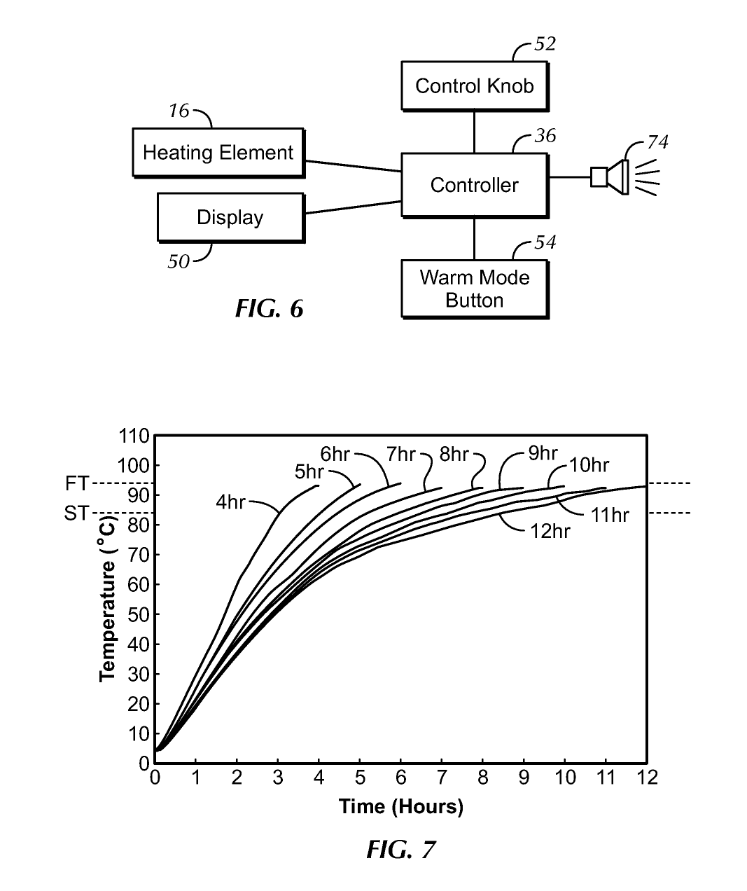

Referring to the drawings in detail, wherein like numerals indicate like elements throughout, FIGS. 2-7 show an embodiment of a kitchen appliance, generally designated 10, according to the present disclosure. The kitchen appliance 10 is illustrated as a slow cooker for warming and/or cooking (collectively referred to as heating) contents (none shown), such as foodstuff or another object, therein. However, the present disclosure is not limited to such a device or functionality. For example, the kitchen appliance 10 may be any of a variety of devices typically used in a kitchen, such as a deep fryer, roaster oven, or the like. In fact, the kitchen appliance 10 could be any type of device having a lid and a container, as described in detail below. The term “foodstuff” as used herein is sufficiently broad to cover any substance that is capable of being consumed by a user, such as a pork roast, vegetables, water, milk or the like, or combination thereof. The kitchen appliance 10 is also capable of heating one or more objects (not shown) other than foodstuff, such as a baby's bottle, one or more stones or towels for a massage, or the like.

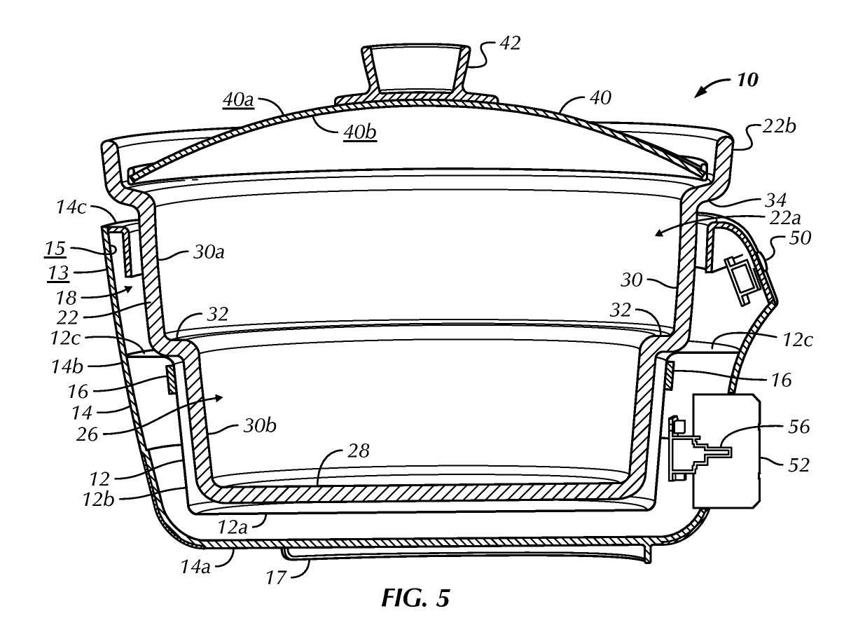

Referring to FIGS. 2, 3 and 5, the kitchen appliance 10 includes an outer shell or housing 14 having a base wall 14a and a side wall 14b extending therefrom. As shown in FIG. 5, interior portions of the base wall 14a and the side wall 14b define a heating cavity 18 within the housing 14. The housing 14 is preferably generally ovular or elliptical in shape when viewed from above or below (see FIG. 4). While the ovular or elliptical shape is preferred, the housing 14 may have a different shape, such as, but not limited to, circular in plan view. As shown in FIG. 5, the side wall 14b of the housing 14 preferably extends generally perpendicularly upwardly from the base wall 14a. The side wall 14b includes an exterior surface 13 that faces the external environment and an opposing interior surface 15 that surrounds and/or establishes the heating cavity 18.

The housing 14 also includes a housing rim 14c at an upper, first, free edge of the side wall 14b that defines an opening to the heating cavity 18. As shown in FIG. 5, at least a portion of the housing rim 14c preferably extends laterally inwardly from the side wall 14b of the housing 14. The base wall 14a may include a support 17 or several spaced-apart, rounded protrusions or feet (not shown) extending downwardly from a bottom surface thereof for supporting the kitchen appliance 10 on a support surface 11 (see FIG. 2), such as a countertop. The support or feet space the bottom surface of the base wall 14a at least slightly above the support surface 11. Alternatively, the kitchen appliance 10 may include omit the support 17 or feet, such that the kitchen appliance 10 is supported by the bottom surface of the base wall 14a directly on the support surface 11.

Referring to FIG. 5, an inner liner 12 is positioned within the heating cavity 18 of the housing 14. The inner liner includes a base wall 12a, a side wall 12b extending upwardly therefrom, and a top wall 12c. The base wall 12a and the top wall 12c preferably extend generally parallel to one another. The side wall 12b of the inner liner 12 preferably extends generally perpendicularly to both the base wall 12a and the top wall 12c. The base wall 12a of the inner liner 12 is preferably vertically spaced-apart a predetermined distance from the base wall 14a of the housing 14 such that a gap or hollow spacing is defined therebetween. Similarly, the side wall 12b of the inner liner 12 is preferably laterally spaced-apart a predetermined distance from the side wall 14b of the housing 14 such that a gap or hollow space is defined therebetween. The top wall 12c of the inner liner 12 is preferably below the housing rim 14c of the housing 14. More specifically, the top wall 12c of the inner liner 12 is preferably positioned approximately at a vertical midpoint of the side wall 14b of the housing 14.

As illustrated in FIGS. 2-4, two spaced-apart handles 20 extend outwardly from opposing portions of the exterior surface 13 of the side wall 14b of the housing 14. The handles 20 enable a user to grasp and/or lift the kitchen appliance 10 for movement thereof. The handles 20 may be in a diametrically opposed relation to one another and disposed along a major axis of the housing 14. The handles 20 can be fixed to the housing 14. Alternatively, at least a portion of each handle 20 may be pivotally attached to the side wall 14b of the housing 14 so that the handles 20 can at least partially fold or collapse to reduce the outer width of the kitchen appliance 10 for storage or shipping purposes.

At least some of the components of the kitchen appliance 10, such as the inner liner 12 and the housing 14, are preferably formed from one or more metallic materials, such as aluminum, stainless steel, or another suitable metallic material, or some combination of metallic materials. One or more of the other components of the kitchen appliance 10, such as the handles 20, may be formed from other, non-metallic materials, such as a polymeric or ceramic material, provided the housing 14 and/or kitchen appliance 10 is capable of functioning as described herein.

Referring specifically to FIG. 5, a heating element 16 is preferably disposed within the housing 14 sufficiently proximate the heating cavity 18 to heat the heating cavity 18. In a preferred embodiment, the heating element 16 is fixed to and extends around an entire outer periphery of the side wall 12b of the inner liner 12. However, the heating element 16 is not limited to such a configuration. For example, the heating element 16 may be disposed at or proximate to the base wall 14a of the housing 14, or the heating element 16 may be located within or on the interior surface of the side wall 14b of the housing 14 in addition to or instead of the base wall 14a of the housing 14 or the side wall 12b of the inner shell 12. The heating element 16 is preferably electrically powered and is a resistance-type heating element, such as a calrod or mica board heating element. However, a different type of heating element may be used, provided the heating element 16 functions to heat the heating cavity 18 of the housing 14. Additionally or alternatively, the heating element 16 may function as a cooling element.

Referring to FIGS. 2, 3 and 5, the kitchen appliance 10 preferably includes a container 22 having a base wall 28 and a side wall 30 extending upwardly therefrom. Interior portions of the base wall 28 and the side wall 30 define a generally hollow interior 22a of the container 22 (see FIG. 5). The interior 22a is capable of retaining the foodstuff therein. A first, free edge of the side wall 30 of the container 22 includes a container rim 22b defining an opening for accessing the interior 22a. At least the container rim 22b of the container 22 preferably extends upwardly beyond the housing rim 14c of the housing 14 when the container 22 is properly positioned within the housing 14. Furthermore, as shown in FIG. 5, it is preferred that at least a portion of the side wall 30 proximate the container rim 22b extends upwardly at least slightly beyond the housing rim 14c of the housing 14 when the container 22 is properly positioned within the housing 14. The container 22 preferably includes a first ledge 34 positioned vertically below the container rim 22b on the side wall 30 thereof. The first ledge 34 preferably extends at least slightly inwardly toward and/or into the interior 22a of the container 22 and extends around the entire periphery of the opening of the container 22.

The container 22 is preferably ovular or elliptical in shape and is sized and shaped to fit at least partially within the heating cavity 18 of the housing 14 for heating thereof by the heating element 16. More specifically, an exterior of the container 22 is preferably at least slightly smaller than the interior of the heating cavity 18 of the housing 14, such that at least a majority of the container 22 can fit within the heating cavity 18. The container 22 is preferably completely and easily removable from the housing 14 and the inner liner 12 to facilitate cleaning thereof without exposing the housing 14, and specifically the heating element 16 and other electrical components thereof, to water and/or cleaning detergents or solvents. However, in an alternative preferred embodiment, the container 22 may be fixed to or integrally and unitarily formed with the housing 14 and/or the inner liner 12. The container 22 is preferably made of stoneware, ceramic or pottery. However, the container 22 may be made of a different material, such as metallic material. For example, the container 22 may be cast iron with a porcelain enamel coating, for instance, provided the container 22 is capable of functioning as described herein.

As shown in FIG. 5, the side wall 30 of the container 22 is preferably stepped or staggered. More specifically, the side wall 30 of the container 22 preferably includes a first or upper portion 30a and a second or lower portion 30b. The first portion 30a is positioned laterally outwardly from the second portion 30b such that a generally horizontally extending second ledge 32 is positioned therebetween. The second ledge 32 preferably extends generally parallel to the base wall 14a of the housing 14 and the base wall 12a and the top wall 12c of the inner liner 12. The first ledge 34, the first portion 30a, the second portion 30b and the second ledge 32 are preferably integrally, unitarily and monolithically formed. The second ledge 32 is preferably positioned vertically below the first ledge 34, and the two ledges 34, 32 are preferably spaced-apart by the first portion 30a of the side wall 30 of the container 22. When the container 22 is properly positioned within the heating cavity 18, as least a portion of the second ledge 32 directly contacts and/or is supported by at least a portion of the top wall 12c of the inner liner 12. The engagement of the second ledge 32 of the container 22 and the top wall 12c of the inner liner 12 creates a gap or hollow spacing between the base wall 28 of the container 22 and the base wall 14a of the housing 14, which is generally closed to define an air volume between the container 22 and the inner liner 12. Such a configuration is advantageous for efficient heating.

Referring to FIGS. 2-5, the kitchen appliance 10 preferably includes a lid 40 sized and shaped to at least partially and preferably completely cover the opening of the container 22 when the lid 40 is placed on the first ledge 34. In an alternative embodiment, the lid 40 and the container rim 22b may be sized and/or shaped such that the lid 40 rests on the container rim 22b. The lid 40 includes a top or exterior surface 40a and an opposing bottom or interior surface 40b (see FIG. 5) that faces the interior 22a of the container 22 when the lid 40 is placed on the first ledge 34 or the container rim 22b. A lid handle 42 preferably extends outwardly from the exterior surface 40a of the lid 40. The lid 40 preferably has at least a slightly arcuate shape, such that the exterior surface 40a is generally convex and the interior surface 40b is generally concave. The lid 40 is preferably generally ovular or elliptical when viewed from above or below to correspond to the shape of the opening of the container 22.

When placed on the first ledge 34 or the container rim 22b, the lid 40 preferably covers the entire opening of the container 22 such that an entire periphery of the lid 40 engages the container rim 22b. The lid 40 is preferably predominantly made of glass, although the lid 40 may be made of a different, preferably transparent or translucent material, such as a polymeric material, for instance, provided the lid 40 functions as described herein. The lid 40 may include a gasket (not shown), as disclosed in U.S. Pat. No. 7,947,928, which is herein incorporated in its entirety by reference, to sealingly engage the lid 40 with the container rim 22b when the lid 40 is placed thereon.

Referring to FIG. 7, the heating element 16 and the kitchen appliance 10 are preferably operable in only a single cooking mode. Thus, the heating element 16 and the kitchen appliance 10 of the present disclosure are distinguishable from those of the prior art, as shown in

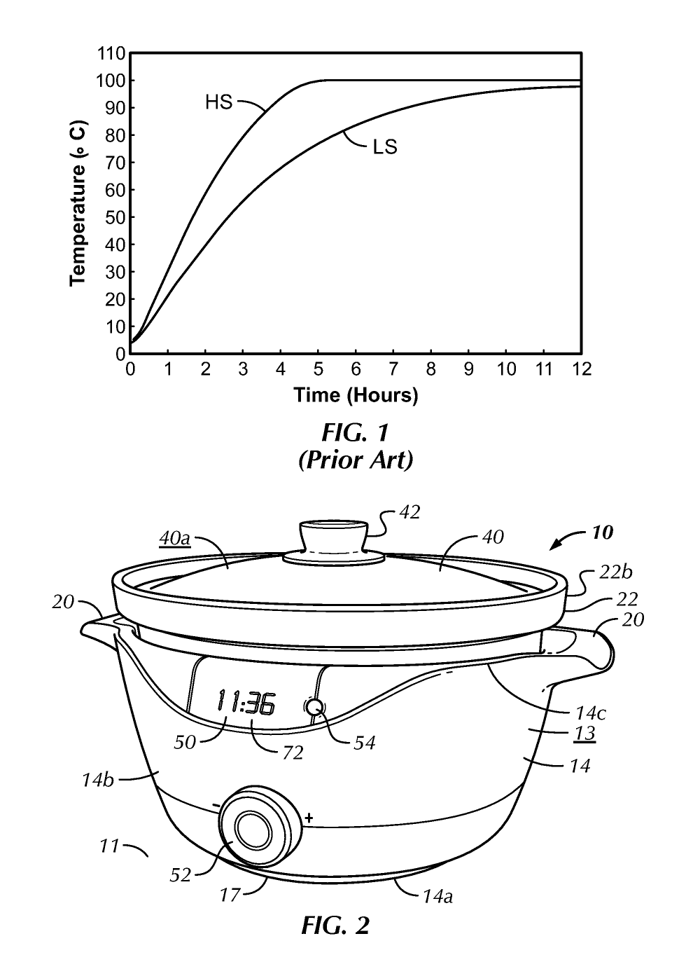

FIG. 1, which typically include at least separate two cooking modes, namely low and high, or sometimes three (or more) separate cooking modes, namely low, medium and high. More specifically, the heating element 16 of the present disclosure preferably has only one cooking setting in which the heating element 16 causes the contents within the container 22 to reach a first predetermined temperature (“FT”) of approximately ninety five degrees Celsius or two hundred three degrees Fahrenheit (95° C. or 203° F.). However, the FT may be higher or lower depending upon the intended functionality or cooking capabilities of the kitchen appliance 10. It is preferred that the FT cannot be modified or changed by the user or consumer.

FIG. 7 shows the contents within the container 22 reaching the FT at the completion or end of nine distinct or discrete time periods ranging from four through twelve hours (4-12 hrs). As described in detail below, the heating element 16 is capable of causing the contents within the container 22 to reach the FT at a specific time (i.e., 8 hrs) within a range of times (i.e., 4-12 hrs). Once the contents within the container 22 reach the FT, the heating element 16 may automatically revert to the single warming mode, as described in detail below, or automatically shut-off. Alternatively, the heating element 16 may continue to operate such that the contents within the container 22 remain at the FT until a certain period of time has elapsed (i.e., until twelve full hours have elapsed) or until the user takes an affirmative step to cease operation of the heating element 16 in the single cooking mode.

The heating element 16 is also preferably operable in only a single warming mode. In the single warming mode, the heating element 16 heats the contents within the container 22 at or to a second predetermined temperature (“ST”). The FT is preferably greater than the ST. More specifically, the ST is preferably approximately eighty five degrees Celsius or one hundred eighty five degrees Fahrenheit (85° C. or 185° F.). However, the ST may be higher or lower depending upon the intended functionality or cooking capabilities of the kitchen appliance 10. It is preferred that the ST cannot be modified or changed by the user or consumer. In other words, it is preferred that the first and second predetermined temperatures (FT, ST) are factory set based on research and development testing to determine the optimum value of each.

Referring to FIG. 7, a controller 36 is preferably mounted to the housing 14 for controlling operation of the heating element 16 in either the single cooking mode or the single warming mode. The controller 36 is not limited to being mounted to the housing 14, but may be mounted to another component of the kitchen appliance 10, such as the inner liner 12. The controller 36 may be operatively connected to or associated with a speaker 74 or other audio device. The controller 36 may actuate the speaker 74 to emit a tone or alarm at the beginning or end, for example, of either or both of the single warming mode and the single cooking mode. For example, the speaker 74 may emit three short tones having a duration of one second (1 s) each and spaced by one second (1 s) silences. Alternatively, the speaker 74 may emit a single generally sustained tone.

The controller 36 may be nearly any variety of controller, such as a microprocessor, that is able to control the heating element 16 and/or the kitchen appliance 10, as will be described in greater detail below, and withstand the normal operating conditions of the kitchen appliance 10. Alternatively, the controller 36 may be a programmable controller and may be comprised of an application-specific integrated circuit (ASIC) that controls operation of the heating element 16 and/or the kitchen appliance 10.

The controller 36 preferably pulses the heating element 16 so that the contents within the container 22 reach the FT at or substantially close to the time selected by the user. That is, the controller 36 intermittently actuates the heating element 16 “on” and “off” with sufficient “on” durations so that the heating element 16 eventually raises the temperature of the contents within the container 22 to the FT. Such intermittent actuation is commonly referred to as a duty cycle, in which the heating element is “off” at a duty cycle of 0% and “on” at a duty cycle of 100%. Stated another way, pulse rates for each time setting (i.e., 4-12 hrs) are preferably selected to achieve the same end temperature (FT) of the contents within the container 22 at each time setting in the single cooking mode.

For example, at the 4 hr cook time shown in FIG. 7, the duty cycle is preferably at a relatively high rate, such as 70%. At the 70% duty cycle, the heating element 16 is “on” for 70% of the time period (i.e., “on” for 2.8 hrs of the selected 4 hr time period) and “off” for 30% of the time period (i.e., “off” for 1.2 hrs of the selected 4 hr time period). Conversely, at the 12 hr cook time shown in FIG. 7, the duty cycle is preferably at a relatively low rate, such as 35%. At the 35% duty cycle, the heating element 16 is “on” for 35% of the time period (i.e., “on” for 4.2 hrs of the selected 12 hr time period) and “off” for 65% of the time period (i.e., “off” for 7.8 hrs of the selected 12 hr time period). At one of the periods of time between the minimum cook time (i.e., 4 hrs) and the maximum cook time (i.e., 12 hrs), the duty cycle of the heating element 16 is preferably at some predetermined value between the high rate and the low rate. The kitchen appliance 10 may function in the above manner through preprogramming without any temperature feedback. Alternatively, the kitchen appliance 10 may include temperature feedback that allows the controller 36 to alter the duty cycles dependent upon one or more variables, such as the volume and/or type of contents within the container 22.

FIG. 7 shows minimal or no overlap for the increase in temperature for the various selected periods of time. However, to comply with certain government or industry regulations, the programmed duty cycle or rate of temperature rise for each selected period of time (4 hrs, 5 hrs, 6 hrs, 7 hrs, etc.) may be approximately the same or identical until a certain temperature and/or time is reached, at which point the duty cycle or rate of temperature rise would vary or diverge. For example, a government or industry regulation for slow cookers may require that foodstuff be heated to at least sixty degrees Celsius (60° C.) after four hours (4 hrs) of cook time. To conform to such a requirement, the duty cycle or rise in temperature for each of the selected periods of time (4 hrs, 5 hrs, 6 hrs, 7 hrs, etc.) may overlap or be identical from the initial start-up or actuation of the heating element 16 until the contents within the container 22 reach sixty degrees Celsius (60° C.) at four hours (4 hrs) of cook time. After the target temperature and time are satisfied, the duty cycle or rise in temperature for each of the selected periods of time (4 hrs, 5 hrs, 6 hrs, 7 hrs, etc.) would differ, such that a larger selected period of time (i.e., 10 hrs) would have a lower duty cycle or slower temperature increase than a smaller selected period of time (i.e., 7 hrs).

Referring to FIGS. 2, 3 and 5, the kitchen appliance preferably includes a control interface to enable a user to control operation of the heating element 16 through the controller 36. The control interface may be a control knob 52 that extends at least partially outwardly from the side wall 14b of the housing 14 to enable a user to control the heating element 16. The control knob 52 is not limited to being mounted to the housing 14, but may be mounted to another component of the kitchen appliance 10, such as the container 22. The control knob 52 is preferably operatively connected to the controller 36 through a rotary switch 56 (see FIG. 5). The control knob 52 is preferably rotatable with respect to the side wall 14b of the housing 14 in both a first rotational direction (i.e., clockwise) and a second rotational direction (i.e., counterclockwise). When electrical power is supplied to the kitchen appliance 10, rotation of the control knob 52 preferably causes and/or initiates the controller 36 to actuate the heating element 16 to cause the contents within the container 22 to reach the FT at or substantially close to the selected amount or period of time. Although the following disclosure describes the control interface as being the control knob 52, the control interface may be in any of a variety of different or alternative forms, such as one or more depressible buttons, slidable switches or the like.

In a preferred embodiment, rotation of the control knob 52 preferably allows a user to select a cooking time in thirty minute (30 min) increments between four to twelve hours (4-12 hrs). However, the kitchen appliance 10 is not limited to such a configuration, as rotation of the control knob 52 may select any preprogrammed time increment between any range of time periods, such as one hour (1 hr) increments between one to ten hours (1-10 hrs) or much smaller increments like 1 minute increments. A beneficial feature of the kitchen appliance 10 of the present disclosure is that a user is prevented from adjusting the FT or the ST, which expedites and simplifies the heating process. Instead, the user's options include selecting between the single cooking mode or the single warming mode, and/or selecting the length of time that the heating element 16 operates in the single cooking mode.

Another beneficial feature is that the contents within the container 22 reaches a completely cooked state as close to the time when the user expects to remove the contents from the kitchen appliance 10. Stated differently, as shown in FIG. 7, any foodstuff or other object within the container 22 reaches the FT at or approximately the time selected by the user through rotation of the control knob 52. The contents within the container 22 do not reach the FT significantly before the user selected period of time, and the heating element 16 does not continue to operate to maintain the contents within the container 22 at the FT significantly after the user selected period of time has elapsed. This feature prevents overcooking of foodstuff or overheating of another object within the container 22. In this manner, a user that cannot attend to their appliance until 5+ hours after starting the cooking process (i.e., activating the heating element 16) will not have exposed the foodstuff to the highest temperature setting for an unnecessary amount of time (see, for comparison, line HS in FIG. 1, wherein foodstuff is subjected to and/or reaches the highest temperature in the HS long after the five hours of cooking have elapsed). Moreover, a user that needs the foodstuff to be prepared or ready to be consumed within 4 to 12 hours can be assured that the proper cooking temperature was reached (see, for comparison, line LS in FIG. 1, wherein the maximum temperature is not reached at the LS until the twelve hours of cooking time have elapsed.). In other words, it is desirable that the user's foodstuff is fully cooked, but should not be overcooked. To the user, the present disclosure presents an “intelligent” appliance that properly prepares the foodstuff based on a single variable (i.e., the time the foodstuff should be ready to be consumed).

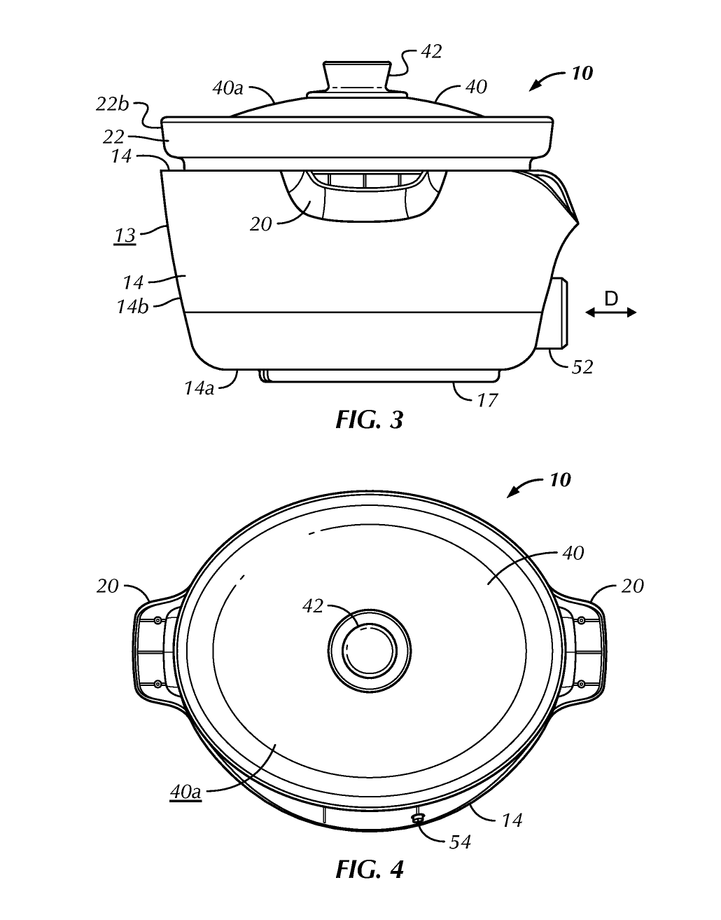

In one preferred embodiment, the entire control knob 52 is depressible or transversely movable with respect to the side wall 14b of the housing 14. More specifically, as shown in FIG. 3, the control knob 52 is preferably movable in a direction D into and away from the side wall 14b of the housing 14. Depression of the control knob 52 may cause and/or initiate one or more steps through the controller 36. For example, depression of the control knob 52 preferably causes the controller 36 to place the heating element 16 in one of an operating condition (i.e., “on”) and a non-operating condition (i.e., “off”). In the non-operating condition, electrical power may be supplied to the kitchen appliance 10 by a conventional power cord (not shown), but the heating element 16 is prevented from operating. Alternatively or additionally, depression of the control knob 52 may switch the heating element 16 from the single cooking mode to the single warming mode, or vice versa.

Referring to FIGS. 2, 5 and 6, the kitchen appliance 10 preferably includes time indicia to allow a user to select an amount of time to operate the kitchen appliance. The time indicia may be a display 50 mounted to or integrally formed with the housing 14. The display 50 is preferably a light emitting diode (LED) or other electronic display positioned above the control knob 52 on the side wall 14b of the housing 14. The display 50 preferably illuminates a cook time indicator or countdown timer 72 in the form of hours and minutes until the selected amount of time lapses. More specifically, the cook time indicator 72 preferably includes seven-segment characters indicating hours and minutes in the format “hh:mm,” which is sometimes known as a 4½ digit display. Alternatively, the time indicia may simply be static numerals, letters and/or symbols attached to the kitchen appliance 10 that represent various cooking times. Such indicia could be positioned on the exterior surface 13 of the side wall 14b of the housing 14 proximate to or at least partially surrounding the control knob 52.

Referring to FIGS. 2 and 4, one preferred embodiment of the kitchen appliance 10 includes a warm mode button 54 preferably depressible with respect to the side wall 14b of the housing 14. In such an embodiment, depression of the warm mode button 54 preferably causes the controller 36 to actuate the heating element 16 to place the heating element 16 in the single warming mode or out of the single warming mode. For example, depressing the warm mode button 54 when the heating element 16 is in the single cooking mode causes the controller 36 to place the heating element 16 in the single warming mode.

The warm mode button 54 is preferably spaced-apart from the control knob 52 on the housing 14. However, the warm mode button 54 is not limited to the above-described configuration, and the kitchen appliance 10 is not limited to the inclusion of the control knob 52 and the separate warm mode button 54. For example, the warm mode button 54 may be embedded or located within the control knob 52, or the warm mode button 54 could even be a rotatable dial. Furthermore, the warm mode button 54 may be completely eliminated, such that depression of the control knob 52 could perform the functionality of the warm mode button 54 described above. The kitchen appliance 10 may include the warm mode button 54 in an alternative embodiment in which the control knob 52 is not depressible, such that the warm mode button 54 is the only means by which a user can effectuate the single warming mode, aside from allowing the controller 36 to automatically change the heating element 16 from the single cooking mode to the single warming mode, as described in detail below. In such an alternative embodiment, depression of the control knob 52 may only function to place the heating element in the operating condition (i.e., “on”) or the non-operating condition (i.e., “off”).

In use, the container 22 is preferably placed at least partially within the heating cavity 18 of the housing 14 and contents are inserted into the hollow interior 22a of the container 22 for cooking, warming and/or cooling thereof. The lid 40 is preferably placed on the container rim 22b. The power cord may be connected to an electrical outlet (not shown) before or after any of the above steps. In an embodiment that includes the electronic display 50, the display 50 is preferably not illuminated until a user performs at least one of the following steps. However, in an alternative embodiment, the display 50 may illuminate once the power cord is inserted into the electrical outlet, or once power is supplied to the kitchen appliance 10.

To place the heating element 16 in the single cooking mode, a user engages the control interface to select a cooking time. The cooking time may be selected from one of a plurality of possible cooking times statically displayed or printed on the kitchen appliance 10, or from a plurality of preprogrammed periods of time illuminated by the display 50. More specifically, the user may depress the control knob 52 to first place the heating element 16 in the operating condition. Alternatively, the heating element 16 may be placed in the operating condition after the control knob 52 is first rotated. Once the kitchen appliance 10 is in the operating condition, the display 50 may initially illuminate and/or flash a default cooking time, such as ten hours (10 hrs), to cook the contents within the container 22 to the FT. If a user desires to change the cooking time, the control knob 52 may be turned or rotated to increase (i.e., clockwise rotation) or decrease (i.e., counterclockwise rotation) the desired time to cook the foodstuff at the FT.

As the control knob 52 is rotated, the display 50 preferably scrolls through and/or illuminates the various preprogrammed cooking times (i.e., 4 hrs, 5 hrs, 6 hrs, etc.). The selected cooking time commences preferably after several seconds of the control knob 52 being stationary. In other words, following a brief pause, the controller 36 may be automatically actuated to activate the heating element 16 in response to the user-selected period of time to cause the contents within the container 22 to reach the FT at or near the selected period of time. Alternatively, the selected cooking time may commence by depressing the control knob 52, for example. Operation and/or actuation of the controller 36 is dependent upon and/or modified by the specific period of cooking time selected by the user, as any one selected period of time effectuates a unique preprogrammed duty cycle or pulse rate of the heating element 16 through the controller 36. It is preferred that the cooking time cannot be changed once cooking has commenced. To prematurely cease a selected cooking time, the power cord may be unplugged or the control knob 52 may be depressed, for example, to clear the selected cooking time.

Following actuation of the controller 26 and activation of the heating element 16 in response to the user-selected period of time, the heating element 16 increases a temperature of the contents within the container 22 to the FT. After the selected cooking time commences, the display 50 preferably counts down in one minute (1 min.) increments. The contents within the container 22 preferably reach the FT at or substantially near an end of the selected cooking time. When the display 50 counts down to zero minutes (0 min.), the display preferably illuminates or flashes the term “WARM” and the controller 36 is automatically actuated to active the heating element 16 in the single warming mode to heat the contents within the container 22 at the ST. In other words, the temperature of the contents within the container 22 is permitted and/or required to decrease to the ST at or shortly following completion of the selected period of time.

In one mode of operation, the single warming mode automatically commences immediately or shortly after the selected time period has elapsed, which prevents the foodstuff from being overcooked. However, the user may initiate the single warming mode prior to completion of the selected period of time, thereby prematurely stopping or cutting short the single cooking mode. In other words, the user may engage the control interface prior to completion of the selected period of time to permit or require the temperature of the contents within the container 22 to decrease to the ST prior to completion of the selected period of time. It is preferred that the single warming mode operates for four hours (4 hrs) if there is no intervention by a user, and the heating element 16 preferably automatically shuts off after the single warming mode has completed. Alternatively, while the kitchen appliance 10 is operating at the selected cooking time in the single cooking mode, a user may depress the warm mode button 54 or depress the control knob 52 to place the heating element 18 in the single warming mode.

It will be appreciated by those skilled in the art that changes could be made to the embodiment described above without departing from the broad inventive concept thereof. It is understood, therefore, that this disclosure is not limited to the particular embodiment disclosed, but it is intended to cover modifications within the spirit and scope of the present disclosure as defined by the appended claims.

I claim:

1. A method of heating contents within a slow cooker over a period of time, the slow cooker including a housing having a base wall, a side wall and time indicia, portions of the base wall and side wall defining a heating cavity within the housing, the housing having a housing rim at a free edge of the side wall defining an opening to the heating cavity, a heating element disposed within the housing sufficiently proximate the heating cavity to heat the heating cavity, a container having a generally hollow interior and a container rim defining an opening for accessing the interior thereof, the interior of the container being capable of retaining the contents therein, the container being sized and shaped to fit at least partially within the heating cavity of the housing, a lid sized and shaped to at least partially cover the opening of the container when placed on the container, the lid having an exterior surface and an opposing interior surface facing the interior of the container when the lid is placed on the container, a controller configured to control operation of the heating element, a control interface operatively connected to the controller, the method comprising:
inserting contents into the interior of the container;
placing the lid on the container;
engaging the control interface to select a cooking time;
actuating the heating element in response to the selected cooking time; and
increasing a temperature of the contents within the container to a first predetermined temperature, the contents within the container reaching the first predetermined temperature at or substantially near an end of the selected cooking time.

2. The method of claim 1, further comprising:
decreasing the temperature of the contents within the container to a second predetermined temperature at or shortly following completion of the selected period of time.

3. The method of claim 2, further comprising:
engaging the control interface prior to completion of the selected period of time;
decrease the temperature of the contents within the container to the second predetermined period of time prior to completion of the selected period of time.

4. The method of claim 2, wherein the heating element is operable in only a single cooking mode to heat the contents within the container to the first predetermined temperature and only a single mode to heat the contents within the container to the second predetermined temperature.

5. The method of claim 1, wherein the user is unable to adjust the first predetermined temperature or the second predetermined temperature.

6. The method of claim 1, wherein the controller intermittently actuates the heater between on and off settings with sufficient on durations so that the contents within the container reach the first predetermined temperature at the selected period of time.

7. The method of claim 1, wherein the control interface is a control knob rotatably mounted to the housing and the time indicia is an electronic display, and wherein rotating the control knob with respect to the housing causes the display to illuminate a selected period of time from one of a plurality of preprogrammed periods of time.

8. A slow cooker comprising:
a housing having a base wall and a side wall extending therefrom, portions of the base wall and side wall defining a heating cavity within the housing, the housing having a housing rim at a free edge of the side wall defining an opening to the heating cavity;
a heating element disposed within the housing sufficiently proximate the heating cavity to heat the heating cavity;
a container having a generally hollow interior and a container rim defining an opening for accessing the interior thereof, the interior of the container being capable of retaining contents therein, the container being sized and shaped to fit at least partially within the heating cavity of the housing;
a lid sized and shaped to at least partially cover the opening of the container when placed on the container, the lid having an exterior surface and an opposing interior surface facing the interior of the container when the lid is placed on the container;
a controller configured to control operation of the heating element; and
a control knob mounted to the housing and operatively connected to the controller, the control knob being rotatable with respect to the housing which causes the controller to actuate the heating element to heat the contents within the container to a first predetermined temperature at a selected amount of time, the control knob being depressible with respect to the housing which causes the controller to place the heating element in one of an operating condition and a non-operating condition.

9. The slow cooker of claim 8, wherein the heating element is operable in only a single cooking mode to heat the contents within the container to the first predetermined temperature and only a single mode to heat the contents within the container to a second predetermined temperature, the first predetermined temperature being greater than the second predetermined temperature.

10. The slow cooker of claim 9, wherein depression of the control knob with respect to the side wall of the housing when the heating element is operating in the single cooking mode actuates the controller to activate the heating element to heat the contents within the container to the second predetermined temperature.

11. The slow cooker of claim 8, wherein rotation of the control knob allows a user to select a cooking time in thirty minute increments between four to twelve hours.

12. The slow cooker of claim 8, wherein a user is prevented from varying a cooking temperature.

13. The slow cooker of claim 8, further comprising:
a light emitting diode display positioned above the control knob on the housing, the display illuminating a countdown timer in the form of hours and minutes until the selected amount of time will lapse.

14. The slow cooker of claim 8, further comprising:
a warm mode button depressible with respect to the side wall of the housing which causes the controller to place the heating element in or out of a warming mode.

15. The slow cooker of claim 8, wherein the container is removable from the housing, and wherein the container is formed of one of a ceramic material and a metallic material.

16. A method of heating contents within a slow cooker over a period of time, the slow cooker including a housing having a base wall and a side wall, portions of the base wall and side wall defining a heating cavity within the housing, the housing having a housing rim at a free edge of the side wall defining an opening to the heating cavity, a heating element disposed within the housing sufficiently proximate the heating cavity to heat the heating cavity, a container having a generally hollow interior and a container rim defining an opening for accessing the interior thereof, the interior of the container being capable of retaining the contents therein, the container being sized and shaped to fit at least partially within the heating cavity of the housing, a lid sized and shaped to at least partially cover the opening of the container when placed on the container, the lid having an exterior surface and an opposing interior surface facing the interior of the container when the lid is placed on the container, a controller configured to control operation of the heating element, a control knob mounted to the housing and operatively connected to the controller, the method comprising:
inserting contents into the interior of the container;
placing the lid on the container;
depressing the control knob with respect to the housing to place the heating element in an operating condition; and
rotating the control knob with respect to the housing which causes the controller to actuate the heating element in a cooking mode to heat the contents within the container to a first predetermined temperature at a selected period of time.

17. The method of claim 16, further comprising:
depressing a warm mode button on the housing to place the heating element in a warming mode, wherein the warm mode button is spaced-apart from the control knob on the housing.

18. The method of claim 16, further comprising:
depressing the control knob with respect to the housing to place the heating element in a warming mode in which the contents within the container reach a second predetermined temperature, wherein the first predetermined temperature is greater than the second predetermined temperature.

19. The method of claim 16, further comprising:
depressing the control knob to place the heating element in a non-operating condition.

20. The method of claim 16, further comprising:
automatically switching the heating element to a warming mode in which the contents within the container reach a second predetermined temperature following completion of the selected period of time in the cooking mode, wherein the first predetermined temperature is greater than the second predetermined temperature.
